(19) United States
(12) Patent Application Publication
(10) Pub. No.: US 2019/0110649 A1
(43) Pub. Date: Apr. 18, 2019

(54) ROTARY BUFFER CAPABLE OF ADJUSTING DAMPING

(71) Applicant: Hoti (Xiamen) Plumbing Inc., Xiamen (CN)

(72) Inventor: Guobin Chen, Xiamen (CN)

(21) Appl. No.: 15/730,753

(22) Filed: Oct. 12, 2017

(51) Int. Cl. A47K 13/26; A47K 13/12; E05F 3/22; E05F 3/20

(52) U.S. Cl. CPC A47K 13/26; E05F 3/20; E05F 3/225; A47K 13/12

(57) ABSTRACT

A rotary buffer capable of adjusting damping includes a shaft sleeve, a rotating shaft, two oil valve plates, and an adjusting nut. An outer wall of a spindle is provided with wing plates. A left curved surface and a right curved surface of the spindle are arranged in a symmetrical and interlaced manner to form an oil gap. Each wing plate is mated with a corresponding one of the oil valve plates. Two sides of each wing plate are provided with pressure regulation passages communicating with an inner cavity of the shaft sleeve and an outer end face of a supporting shaft. The adjusting nut is provided with a platform surface to get contact with the outer end face of the supporting shaft for sealing the pressure regulation passages.

### BACKGROUND OF THE INVENTION

### 1. Field of the Invention

The present invention relates to a hydraulic damping rotary buffer applied to a toilet seat cover, and more particularly to a rotary buffer capable of adjusting damping.

### 2. Description of the Prior Art

A conventional hydraulic damping rotary buffer is mainly composed of a shaft sleeve, a rotating shaft and a one-way oil valve plate and the like. Through the rotating shaft to disturb the damping oil in the shaft sleeve, the oil valve plate opens the oil passage so that the damping oil rapidly flows in a one-way direction. The damping oil has no hydraulic resistance to act on the rotating shaft, so the rotating shaft can be quickly turned. When the rotating shaft is rotated reversely, the oil plate is swung an angle to close the oil passage to make the damping oil flow slowly. The damping oil generates hydraulic resistance to act on the rotating shaft so that the rotating shaft is rotated slowly. Therefore, by adjusting the hydraulic resistance of the damping oil in the shaft sleeve (the high the oil speed, the less the hydraulic resistance, the less the damping), the rotational speed of the rotating shaft can be adjusted.

A conventional rotary hydraulic damper, such as a rotary buffer disclosed in Chinese Patent Early Publication No. CN101785645A, comprises a cylinder and a spindle. A partition provided at the middle portion of the cylinder for supporting the distal end of the spindle is provided with two or four convection holes for damping oil to flow therethrough. The interior of the other end of the cylinder is provided with a storage channel in communication with the convection holes. A movable regulating member is provided in the storage channel to adjust the size of the storage channel Through the regulating member to control the size of the storage channel, the flow rate of the damping oil flowing through the convention holes and the storage channel can be adjusted to control the rotational speed of the rotating shaft. The above-mentioned rotary buffer has many components for damping oil adjustment. The structure is complex, and the assembling efficiency is low. The arrangement of the partition and the complicated regulating member increases the length of the cylinder, which is not conducive to the miniaturization of the damper.

A buffer without partition is developed as disclosed in Chinese Utility Model Publication No. CN2664575Y titled “DAMPING ASSEMBLY OF TOILET SEAT COVER”. The distal end of an oil core is connected with a fixing screw fixed to an oil storage tank. The distal end of an oil core is rotatbly mated with a shaft hole in the middle of the fixing screw. When in use, the oil core may drive the fixing screw to unscrew, resulting in a larger gap between the oil core and the end face of the fixing screw. As a result, the hydraulic pressure of the damping oil is unstable and the rotational speed of the oil core is unstable, affecting the use of the damping assembly.

For the rotary hydraulic damper and the buffer with partition, in the actual action process, only the last half stroke needs to slow down. But, the existing dampers can only achieve the function of slowing down in the whole stroke.

Accordingly, the inventor of the present invention has devoted himself based on his many years of practical experiences to solve these problems.

### SUMMARY OF THE INVENTION

The primary object of the present invention is to provide a rotary buffer capable of adjusting damping which has a simple structure and a stable function.

In order to achieve the aforesaid object, the rotary buffer capable of adjusting damping of the present invention comprises a shaft sleeve capable of being filled with a damping oil, a rotating shaft hermetically and rotatably mated with the shaft sleeve and capable of disturbing the damping oil, two oil valve plates, and an adjusting nut. The shaft sleeve has an inner cavity and a shaft through hole. A wall of the inner cavity of the shaft sleeve is provided with two oil separating ribs. The rotating shaft has a spindle and a supporting shaft. The supporting shaft is connected with the one end of the spindle. Another end of the supporting shaft is inserted to one end of the shaft through hole of the shaft sleeve and mated with the shaft through hole. Another end of the shaft through hole is threadedly connected with the adjusting nut. An outer wall of the spindle is provided with two opposing wing plates. The wing plates divide the spindle into a left curved surface and a right curved surface. The left curved surface and the right curved surface are arranged in a symmetrical and interlaced manner so that two ends of each wing plate and the left and right curved surfaces form a high junction and a low junction. The lower junction is formed with an oil gap. Each wing plate is mated with a corresponding one of the oil valve plates and slidably mated with the wall of the inner cavity of the shaft sleeve. Each oil valve plate is provided with at least one oil hole. Two sides of each wing plate of the rotating shaft are provided with pressure regulation passages communicating with the inner cavity of the shaft sleeve and an outer end face of the supporting shaft. The adjusting nut is provided with a platform surface to get contact with the outer end face of the supporting shaft for sealing the pressure regulation passages.

Preferably, each oil valve plate has two vertical sides and a transverse side to form a U-shaped configuration. One of the two vertical sides is mated with a corresponding one of the wing plates. The other vertical side is provided with two spaced oil holes. The transverse side of each oil valve plate has a size greater than a thickness of the corresponding wing plate of the rotating shaft. The corresponding wing plate is disposed between the two vertical sides of each oil valve plate. The two oil valve plates are disposed between the two oil separating ribs of the shaft sleeve.

Preferably, the rotating shaft includes a rotating ring rotatably mated with an opening of the inner cavity of the shaft sleeve. One end of the rotating ring is connected with the spindle. The end of the rotating ring, connected with the spindle, is an inner annular surface. The inner annular surface of the rotating ring is slidably mated with tops of the oil separating ribs. The inner annular surface is provided with a pair of oil grooves to open oil passages at two sides of the oil separating ribs when the rotating shaft is not rotated.

Preferably, an outer circumference of the rotating ring of the rotating shaft is formed with a neck. A sealing ring is fitted in the neck to seal the rotating ring and the opening of the shaft sleeve.

Preferably, the wing plates of the rotating shaft are disposed between an inner end face of the supporting shaft and the inner annular surface of the rotating ring. One end of each wing plate is connected to the inner annular surface of the rotating ring. Another end face of each wing plate is slidably mated with an inner cavity bottom surface of the rotating shaft.

Preferably, the pressure regulation passages are axial grooves extending from the outer end face of the supporting shaft to the spindle. The platform surface is separated from the outer end face of the supporting shaft to form a gap to communicate with each of the axial grooves. By adjusting the platform surface and the gap, the flow rate of the damping oil at both sides of each wing plate can be adjusted when the rotating shaft is rotated. That is, the hydraulic resistance of the damping oil to the wing plates can be adjusted so as to adjust the rotational speed of the rotating shaft.

Preferably, an axial lower end face of each wing plate is in contact with and rotatably mated with a bottom surface of the inner cavity of the shaft sleeve.

Preferably, a bottom surface of the inner cavity of the shaft sleeve is formed with a pair of oil discharge grooves symmetrically arranged beside the two oil separating ribs for the wing plates and axial lower end faces of the oil valve plates to form gaps respectively. When the wing plates of the rotating shaft slide through the oil discharge grooves, the damping oil between the two sides of the wing plates can pass quickly. The damping oil has no hydraulic resistance to the wing plates, so that the cover of the toilet can be lifted easily.

Preferably, the opening of the shaft sleeve is provided with a press lid by welding. A gasket and a sealing ring are provided between the press lid and the rotating ring.

Preferably, the adjusting nut is provided with an annular groove. The annular groove is fitted with an 0-shaped sealing ring for sealing the adjusting nut and the shaft through hole at a bottom of the shaft sleeve.

According to the present invention, by adjusting the adjusting nut and controlling the gap between the end face of the supporting shaft and the platform surface of the adjusting nut, the flow rate of the damping oil in the pressure regulation passages can be adjusted to change the hydraulic difference of the damping oil between the two sides of the wing plates to adjust the hydraulic damping force of the damping oil to act on the wing plates so as to control the rotational speed of the rotating shaft. In particular, the left and right curved surfaces of the spindle are arranged in an interlaced manner to form an oil gap, During the first two-thirds stroke (about 0°-65°) of turning the shaft sleeve upward or downward, the damping oil has no hydraulic damping force to act on the rotating shaft so that the rotating shaft can be quickly rotated and the cover can be quickly moved upward or downward. The damping oil generates flow pressure, which enables the oil valve plate on the wing plate to swing reversely. The other side of the oil valve plate gets contact with the outer wall of the wing plate to close the oil holes. When the oil separating ribs are offset from the oil grooves to get contact with the inner annular surface to enter the last one-third stroke (about 65°-90°) of turning the cover, the oil separating ribs quickly divides the inner cavity of the shaft sleeve into two oil chambers. Because the oil holes are closed, the damping oil can only pass slowly from the oil discharge grooves of the inner cavity bottom surface of the shaft sleeve and the oil gap. The damping oil generates a hydraulic damping force to act on the wing plates, so that the rotating shaft is rotated slowly. The last one-third stroke of turning the cover downward or upward is slow. In the process of turning the cover downward, the first two-thirds stroke is fast and the last one-third stroke is slow. The invention has the advantages of simple structure, convenient damping adjustment, stable and reliable function. In the process of moving the cover upward or downward, the first two-thirds stroke is fast and the last one-third stroke is slow.

### BRIEF DESCRIPTION OF THE DRAWINGS

FIG. 1 is an exploded view of the present invention;

FIG. 2 is another exploded view of the present invention;

FIG. 3 is a perspective view of the shaft sleeve of the present invention;

FIG. 4 is a perspective view of the oil valve plate of the present invention;

FIG. 5 is another perspective view of the oil valve plate of the present invention;

FIG. 6 is a perspective view of the rotating shaft of the present invention;

FIG. 7 is a front view of the rotating shaft of the present invention;

FIG. 7A is a sectional view of FIG. 7;

FIG. 8 is a top view of the rotating shaft of the present invention;

FIG. 9 is a sectional view of the rotating shaft of the present invention;

FIG. 10 is a sectional view of the rotating shaft coupled with the adjusting nut of the present invention;

FIG. 11 is a sectional view of the present invention;

FIG. 12 is a sectional view of the present invention, showing that the rotating shaft is turned clockwise without any damping operation;

FIG. 13 is a sectional view of the present invention, showing that the rotating shaft is turned reversely with half damping operation;

FIG. 14 is a sectional view of the present invention in a 90-degree closed state;

FIG. 15 is a sectional view of the present invention in a 30-degree closed state;

FIG. 16 is a sectional view of the present invention not in a damping adjustment state; and

FIG. 17 is a sectional view of the present invention in a damping adjustment state.

### DETAILED DESCRIPTION OF THE PREFERRED EMBODIMENTS

Embodiments of the present invention will now be described, by way of example only, with reference to the accompanying drawings.

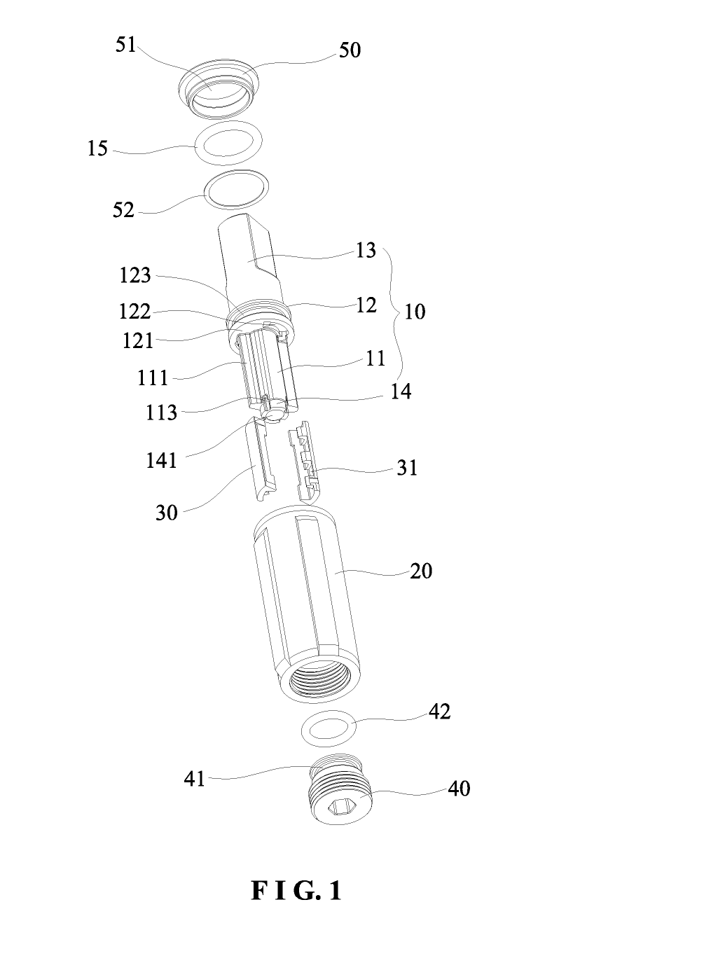

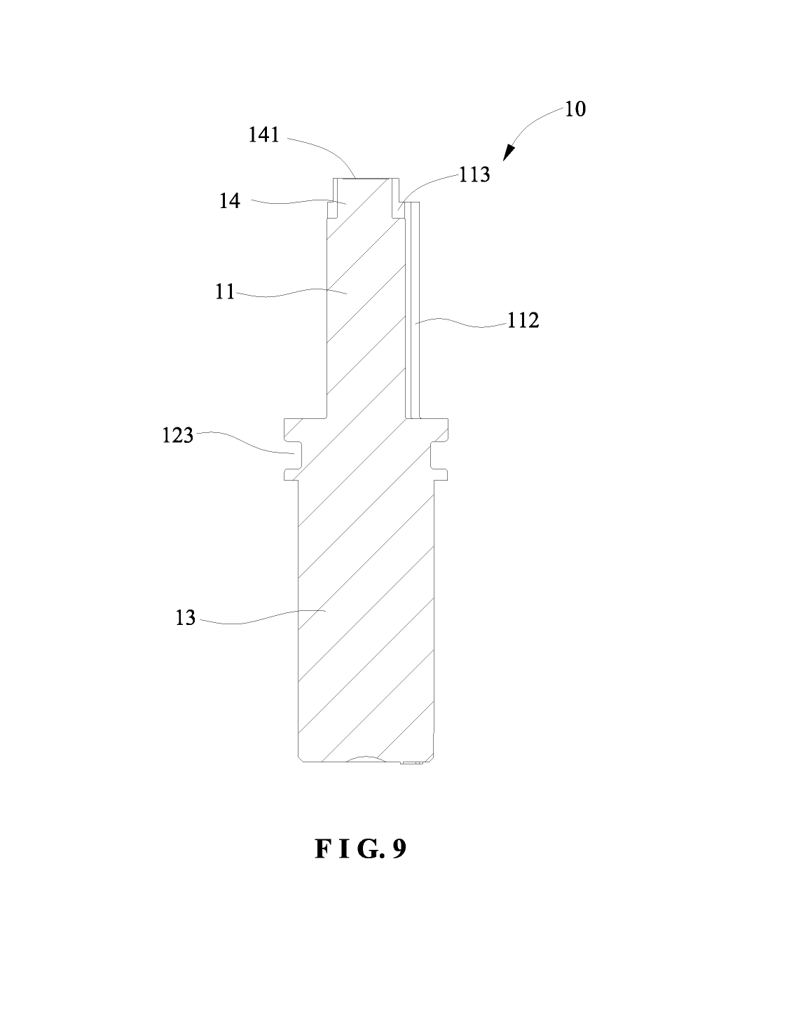

As shown in FIG. 1 to FIG. 17, the present invention discloses a rotary buffer capable of adjusting damping. The rotary buffer comprises a rotating shaft 10, a shaft sleeve 20, oil valve plates 30, an adjusting nut 40, and a press lid 50.

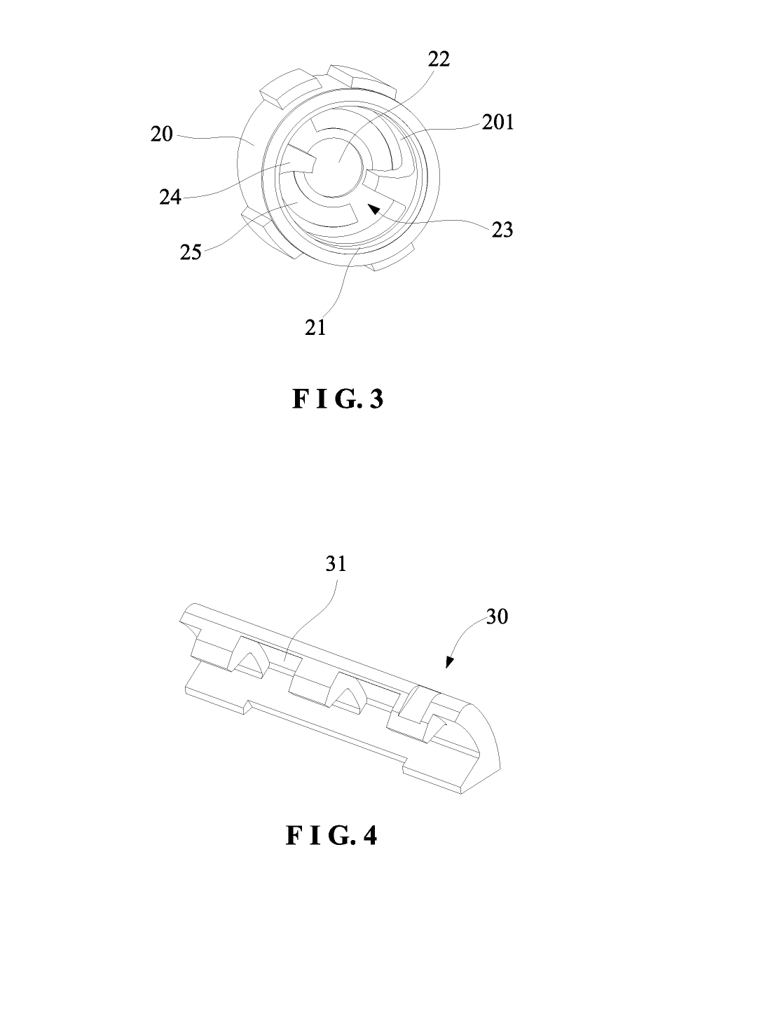

As shown in FIG. 3, the shaft sleeve 20 of the present invention has an inner cavity 201, an opening 21 for the rotating shaft 10 to be inserted therein, and a shaft through hole 22 for supporting the rotation of the distal end of the rotating shaft 10. An inner cavity bottom surface 23 is formed between the inner cavity 201 and the shaft through hole 22. The shaft sleeve 20 includes two oil separating ribs 24 therein. The two oil separating ribs 24 are symmetrically disposed on the wall of the inner cavity 201 of the shaft sleeve 20. The radial surface of each oil separating rib 14 is flash with the shaft through hole 22. The oil separating ribs 24 extend from the opening 21 to the inner cavity bottom surface 23 to be fixed. The oil separating ribs 24 are flush with the opening 21. The inner cavity bottom surface 23 of the shaft sleeve 20 is formed with a pair of oil discharge grooves 25 symmetrically arranged beside the two oil separating ribs 24.

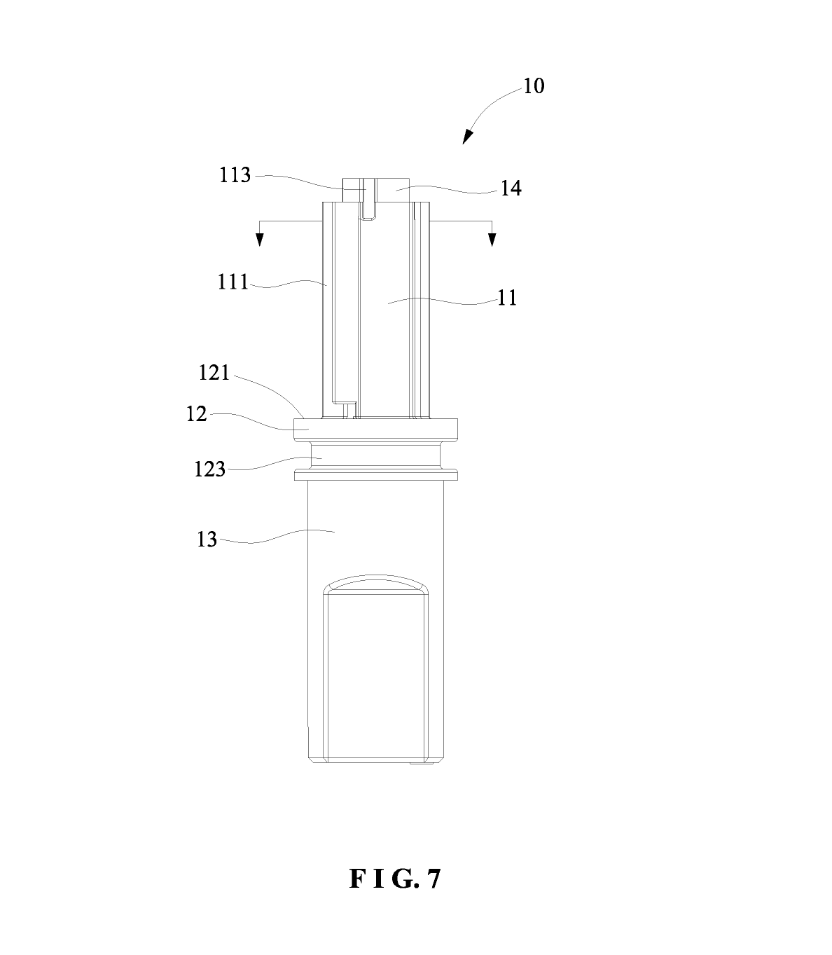

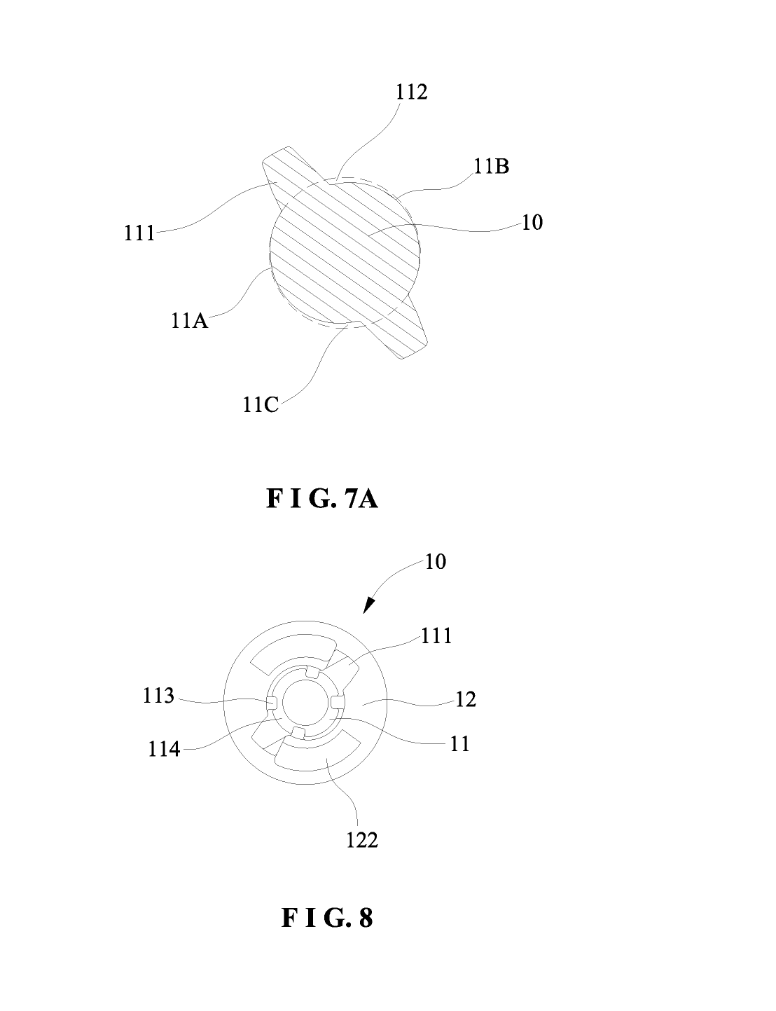

As shown in FIG. 6 to FIG. 9, the rotating shaft 10 of the present invention includes a spindle 11 inserted in the inner cavity 201 of the shaft sleeve 20, a rotating ring 12 rotatably mated with the opening 21 of the shaft sleeve 20, a connecting portion 13 extending out of the shaft sleeve 20, and a supporting shaft 14 connected to one end of the spindle 11. The connecting portion 13 is used for connecting and cooperating with the resolving shaft of the toilet (not shown). The supporting shaft 14 is disposed at one end of the spindle 11, opposite to the rotating ring 12. The supporting shaft 14 can be inserted in the shaft through hole 22 of the shaft sleeve 20. The spindle 11 is provided with a pair of wing plates 111 which are symmetrically disposed between one end of the spindle 11 connected with the supporting shaft 14 and an inner annular surface 121 of the rotating ring 12. One end of each wing plate 111 is connected to the inner annular surface 121 of the rotating ring 12, and another end face of each wing plate 111 is slidably mated with the inner cavity bottom surface 23. As shown in FIG. 7A, the wing plates 111 divide the spindle 11 into a left curved surface 11A and a right curved surface 11B. The left curved surface 11A and the right curved surface 11B are arranged in a symmetrical and interlaced manner so that two ends of each wing plate 111 and the left and right curved surfaces 11A, 11B form a high junction and a low junction. The lower junction is formed with an oil gap 112. The inner annular surface 121 of the rotating ring 12 is slidably mated with the tops of the oil separating ribs 24. The inner annular surface 121 is provided with a pair of oil grooves 122 to open the oil passages at two sides of the oil separating ribs 24 when the rotating shaft 10 is not rotated. The outer end face of the supporting shaft 14, corresponding to both sides of each wing plate 111, is provided with four axial grooves 113 extending to the spindle 11. The axial grooves 113 serve as pressure regulation passages. The outer circumference of the rotating ring 12 of the rotating shaft 10 is formed with a neck 123. A sealing ring 15 is fitted in the neck 123 to seal the rotating ring 12 and the opening 21 of the shaft sleeve 20.

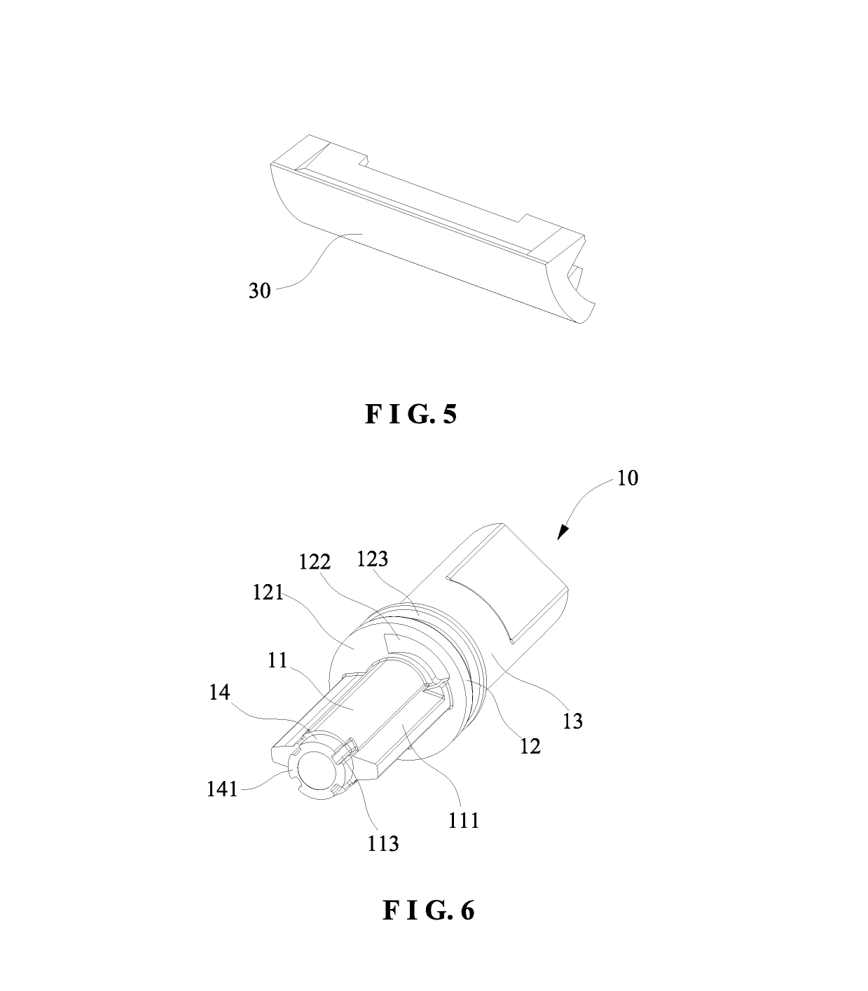

As shown in FIG. 4 and FIG. 5, each wing plate 111 of the rotating shaft 10 is mated with one of the oil valve plates 30. Each oil valve plate 30 has two vertical sides and a transverse side to form a U-shaped configuration. One of the two vertical sides is mated with the corresponding wing plate 111, and the other of the two vertical sides is provided with two spaced oil holes 31. The size of the transverse side of the oil valve plate 30 is greater than the thickness of the corresponding wing plate 111 of the rotating shaft 10. The wing plate 111 is disposed between the two vertical sides of the oil valve plate 30. The two oil valve plates 30 are disposed between the two oil separating ribs 24 of the shaft sleeve 20.

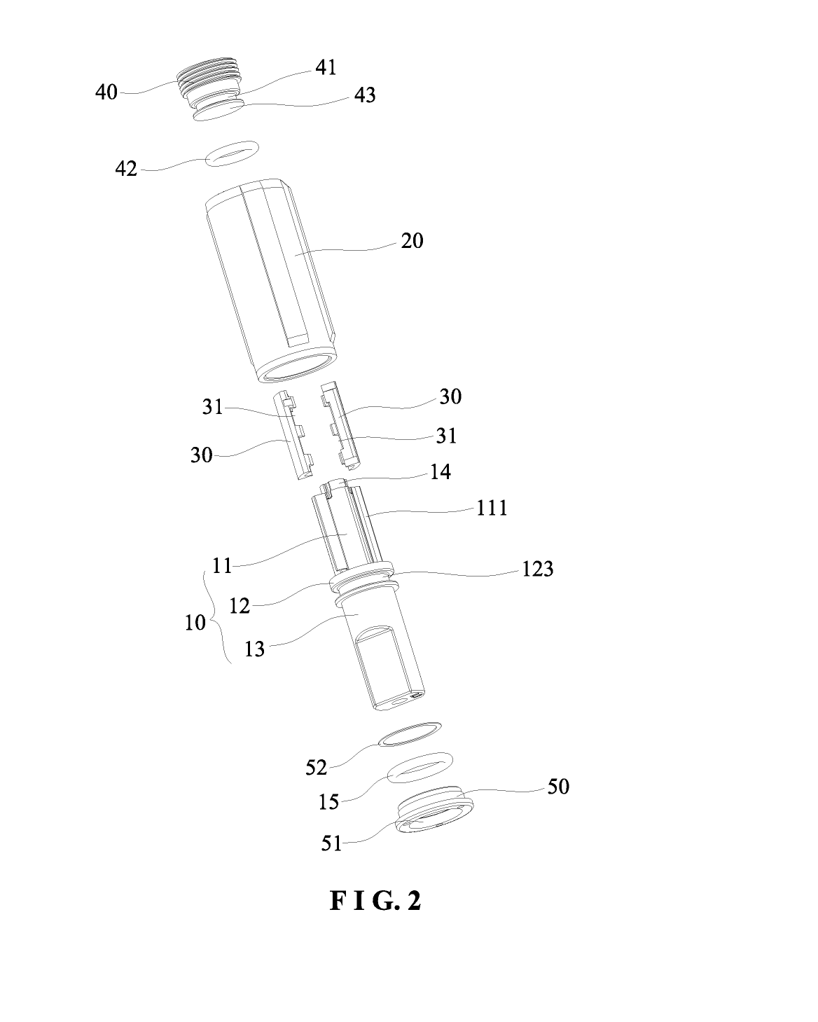

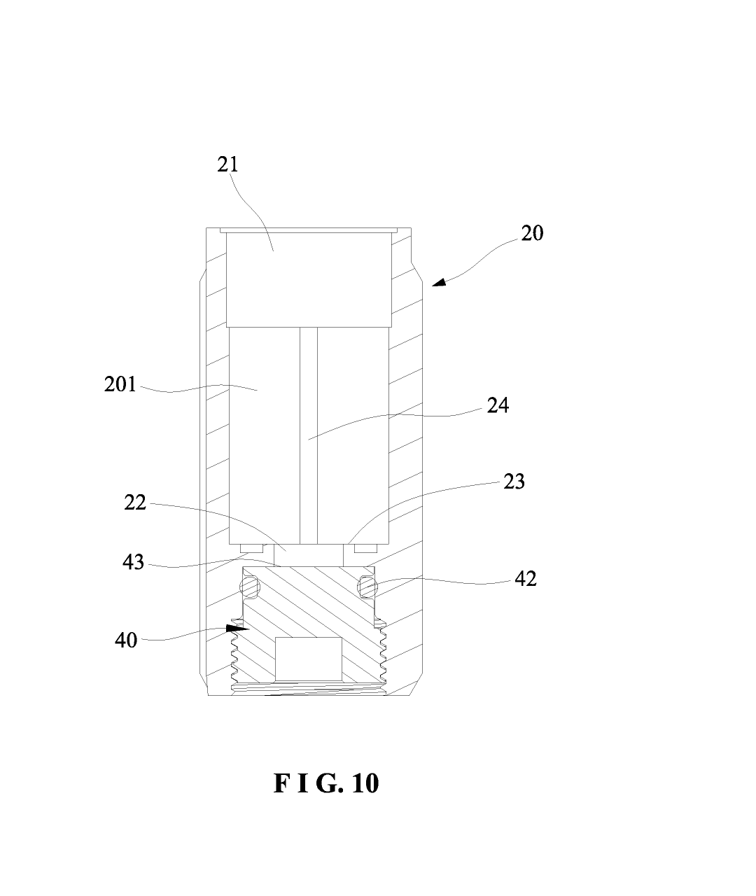

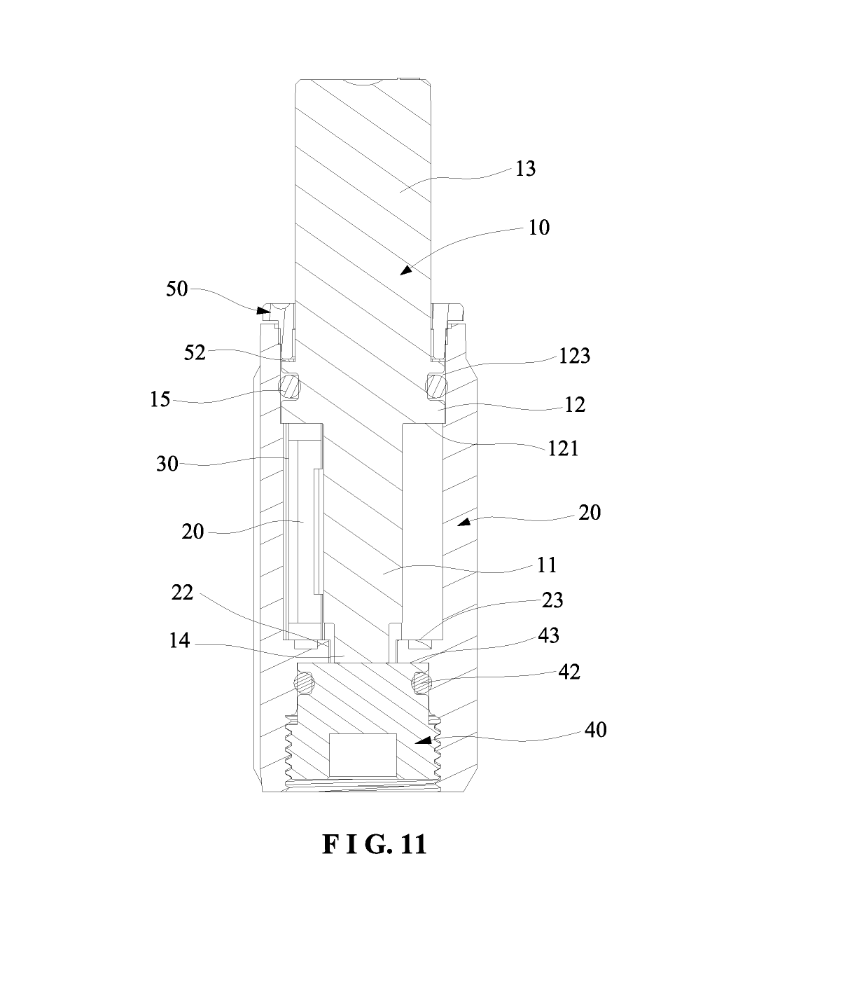

As shown in FIG. 1, FIG. 2, FIG. 10 and FIG. 11, the shaft through hole 22 of the present invention is threadedly connected with the adjusting nut 40. The distal end of the adjusting nut 40 is provided with a platform surface 43 to get contact with the outer end face 141 of the supporting shaft 14 for sealing the axial grooves 113. The adjusting nut 40 is provided with an annular groove 41. The annular groove 41 is fitted with an 0-shaped sealing ring 42 for the adjusting nut 40 and the shaft through hole 22 at the bottom of the shaft sleeve 20 to be sealed.

As shown in FIG. 1 and FIG. 2, the press lid 50 is fitted to the opening 21 of the shaft sleeve 20. The press lid 50 has a central hole 51 through which the connecting portion 13 of the rotating shaft 10 passes. A gasket 52 is provided between the press lid 50 and the rotating ring 12 of the rotating shaft 10.

As shown in FIG. 1, FIG. 2 and FIG. 11, the two vertical sides of each oil valve plate 30 are fitted on each wing plate 111 of the spindle 11 of the rotating shaft 10. The neck 123 of the rotating ring 12 is fitted in the sealing ring 15, and then the whole is fitted into the inner cavity 201 of the shaft sleeve 20. The edges of the oil valve plates 30 are slidedly mated with the wall of the inner cavity 201. The lower end face of each wing plate 111 is slidedly mated with the inner cavity bottom surface 23. Each wing plate 111 is located between the two oil separating ribs 24. The rotating ring 12 of the rotating shaft 10 is rotatably mated with the opening 21. The tops of the oil separating ribs 24 are in contact with and slidably mated with the inner annular surface 121 of the rotating ring 12. The oil separating ribs 24 are in contact with and slidably mated with the radial surface of the rotating shaft 10. The two oil separating ribs 24 divide the shaft sleeve 20 into two oil chambers for storing damping oil. The supporting shaft 14 at the bottom of the spindle 11 is rotatably fitted in the shaft through hole 22 of the shaft sleeve 20. The adjusting nut 40 is screwed in the shaft through hole 22, with the platform surface 43 at the distal end of the adjusting nut 40 to seal the axial grooves 113 of the outer end face 141 of the supporting shaft 14. The two oil chambers 24 separated by the oil separating ribs 24 are not communicated with each other. Then, the gasket 52 is fitted on the outer annular surface of the rotating ring 12. The press lid 50 is pressed in the opening 21 and fixed by welding to complete the assembly of the present invention.

The details of the working principle of the present invention will be described below.

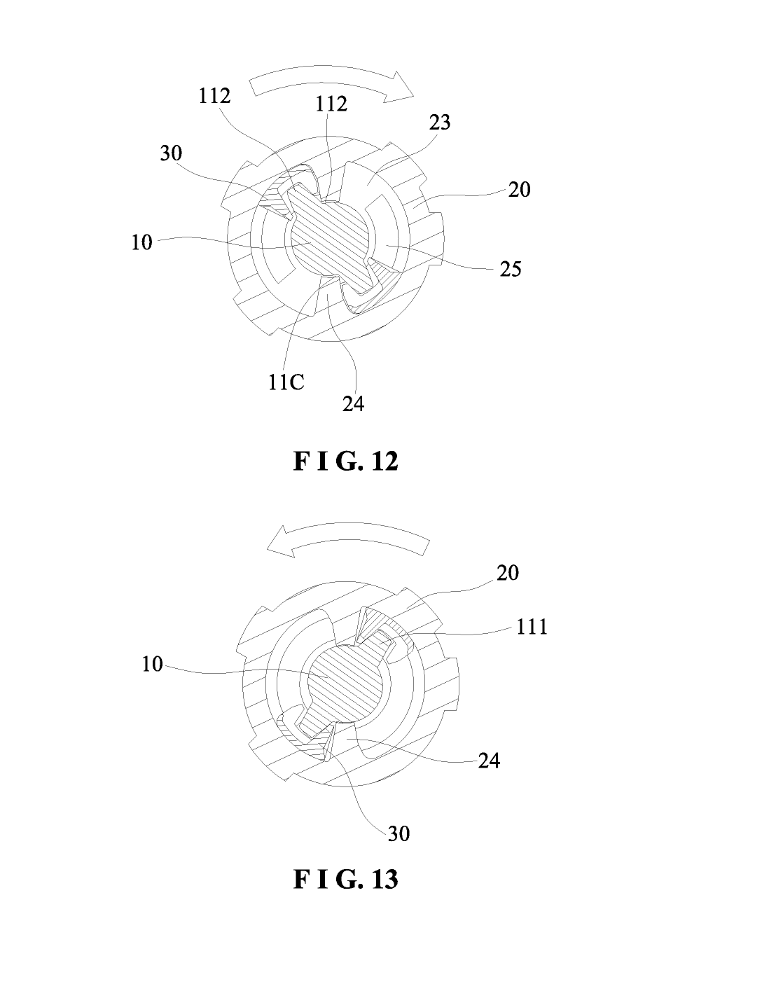

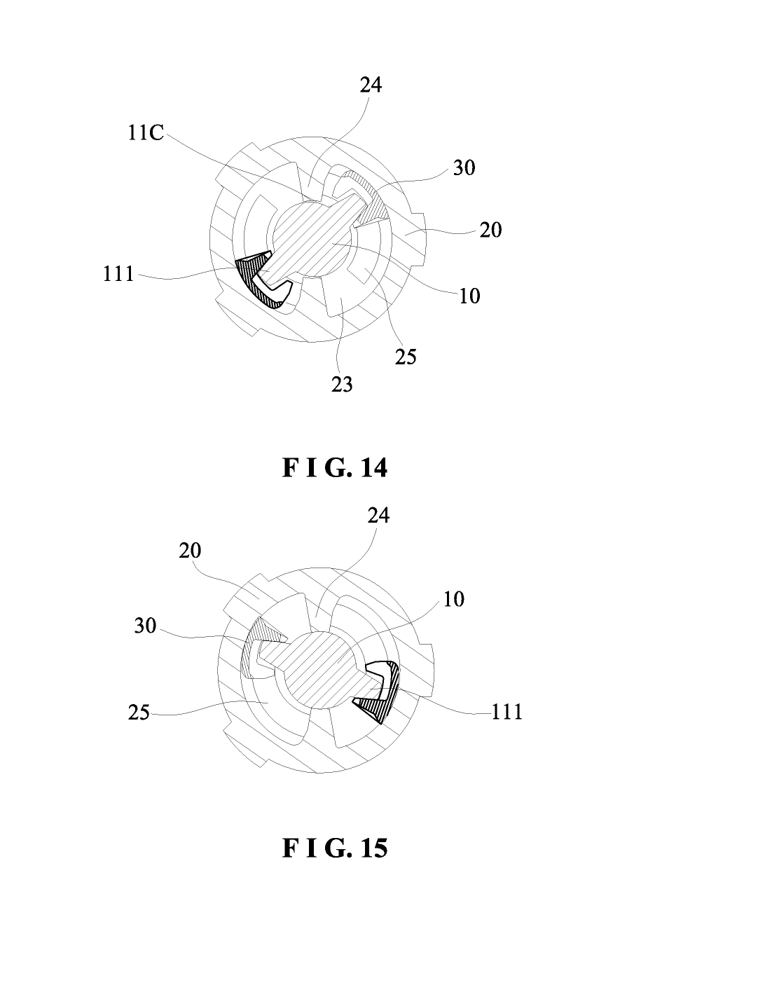

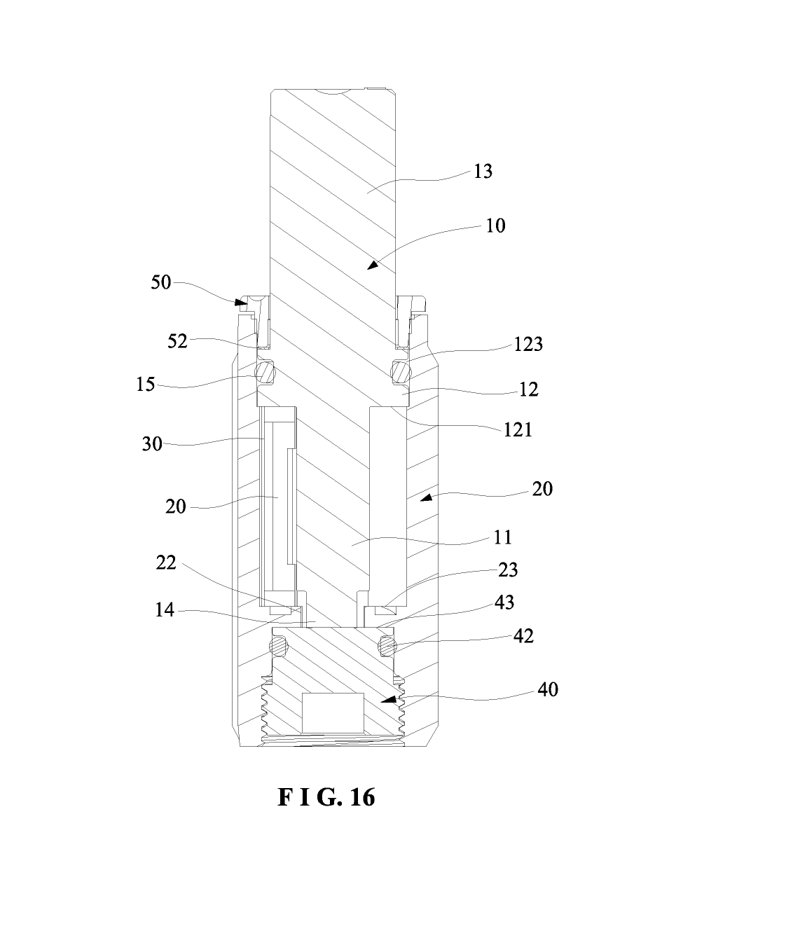

As shown in FIG. 16, by screwing the adjusting nut 40, the platform surface 43 is used to block the axial grooves 113 of the outer end face 141 of the supporting shaft 14 so that the oil chambers separated by the oil separating ribs 24 cannot be communicated with each other, that is, the damping oil is confined in the oil chambers. The toilet seat cover (not shown) is connected to the connecting portion 13 of the rotating shaft 10. As shown in FIG. 12, FIG. 14 and FIG. 15, during the process of turning the cover upward, when the wing plates 111 on the rotating shaft 10 slides over the oil discharge grooves 25 of the inner cavity bottom surface 23 of the shaft sleeve 20, the damping oil rapidly passes through the oil discharge grooves 25, while the wing plates 111 disturb the damping oil. The flowing pressure of the damping oil enables the oil valve plates 30 on the wing plates 111 to swing so as to form an oil passage, and the damping oil quickly passes through the oil holes 31. The left curved surface 11A and the right curved surface 11B are disposed in an interlaced manner to form the oil gap 112. When the cover is turned upward to the two-thirds stroke, the damping oil has no hydraulic resistance to act on the wing plates 111 so that the first two-thirds stroke of turning the cover upward is very light. When the cover is turned to the two-thirds stroke, the oil separating ribs 24 slide over the oil grooves 122 on the inner annular surface 121 of the rotating ring 12 of the rotating shaft 10 so that the two oil chambers separated by the oil separating ribs 24 of the shaft sleeve 20 are communicated with each other. The damping oil can flow freely in the inner cavity 201 of the shaft sleeve 20 so that the damping oil has no hydraulic damping force to act on the wing plates 111 and the damping oil has no hydraulic damping force to act on the rotating shaft 10. However, the shaft sleeve 20 will touch the vertical sides of the oil valve plates 30 after the last one-third stroke, so the process of turning the cover is blocked. The cover needs to drive the oil valve plates 30 and the wing plates 111 to turn together when the cover is at the last one-third stroke. Therefore, in the process of turning the cover, the first two-thirds stroke is fast and the last one-third stroke is slow. Since the damping oil has no hydraulic damping force to act on the rotating shaft 10, even though the last one-third stroke is slow, it is not laborious, preventing the cover from colliding with the toilet to be damaged due to a fast turning.

As shown in FIG. 17 and FIG. 13 to FIG. 15, in the first half process of turning the cover, the oil separating ribs 24 of the shaft sleeve 20 reversely slide over the oil grooves 122 of the inner annular surface 121 of the rotating ring 12 of the rotating shaft 10, so that the two oil chambers separated by the oil separating ribs 24 are communicated with each other. The damping oil can flow freely in the inner cavity 201 of the shaft sleeve 20 so that the damping oil has no hydraulic damping force to act on the wing plates 111. The wing plates 111 are eccentrically disposed relative to the shaft sleeve 20, so that the damping oil has no hydraulic damping force to act on the rotating shaft 10 in the first two-thirds stroke of turning the cover downward. The rotating shaft 10 can be rotated rapidly, and the cover can be quickly turned downward. The damping oil generates flowing pressure to swing the oil valve plates 30 on the wing plates 111 reversely.

The other side of each oil valve plate 30 is in close contact with the outer wall of the wing plate 111 to close the oil holes 31. When the oil separating ribs 24 are offset from the oil grooves 122 to get contact with the inner annular surface 121 to enter the last one-third stroke of turning the cover, the oil separating ribs 24 quickly divides the inner cavity 201 of the shaft sleeve 20 into two oil chambers. Because the oil holes 31 are closed, the damping oil can only pass slowly from the oil discharge grooves 25 of the inner cavity bottom surface 23. The damping oil generates a hydraulic damping force to act on the wing plates 111, and the rotating shaft 10 is rotated slowly, such that the last one-third stroke of turning the cover downward is slow. In the process of turning the cover downward, the first two-thirds stroke is fast and the last one-third stroke is slow.

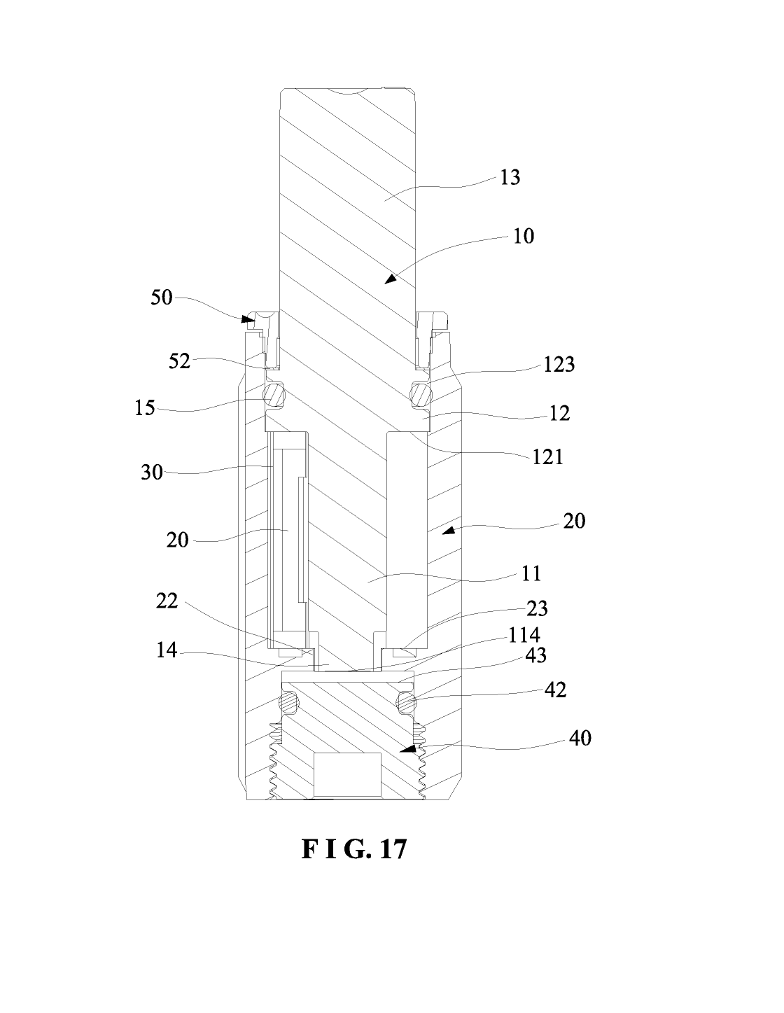

As shown in FIG. 13, in the last half stroke of turning the cover downward, the damping oil slowly passes from the oil discharge grooves 25 of the inner cavity bottom surface 23 of the shaft sleeve 20, the damping oil generates a hydraulic damping force to act on the wing plates 111, so that the rotating shaft 11 is rotated slowly. If it is necessary to adjust the rotational speed of the damping working state of the rotating shaft 10, the magnitude of the hydraulic damping force of the damping oil to act on the wing plates 111 must be adjusted. As shown in FIG. 16 and FIG. 17, the adjusting nut 40 is rotated reversely to separate the platform surface 43 from the outer end face 141 of the supporting shaft 14 of the rotating shaft 10 to open the axial grooves 113 so that the two oil chambers separated by the oil separating ribs 24 are communicated with each other through the axial grooves 113. The axial grooves 113, the shaft through hole 22, and the platform surface 43 of the adjusting nut 40 constitute an oil passage which controls the flow rate of the damping oil in the inner cavity 201. By rotating the adjustment nut 40, the gap between the platform surface 43 and the outer end face 141 of the supporting shaft 14 can be adjusted to control the flow rate of the damping oil in the oil chambers from each axial groove 113 to change the hydraulic damping force of the damping oil to act on the wing plates 111 so as to adjust the rotational speed of the rotating shaft 10, such that the turning speed of the cover can be adjusted.

Although particular embodiments of the present invention have been described in detail for purposes of illustration, various modifications and enhancements may be made without departing from the spirit and scope of the present invention. Accordingly, the present invention is not to be limited except as by the appended claims.

1. A rotary buffer capable of adjusting damping, the rotary buffer comprising: a shaft sleeve capable of being filled with a damping oil, a rotating shaft hermetically and rotatably mated with the shaft sleeve and capable of disturbing the damping oil, two oil valve plates, and an adjusting nut; the shaft sleeve having an inner cavity and a shaft through hole, a wall of the inner cavity of the shaft sleeve being provided with two oil separating ribs, wherein the rotating shaft has a spindle and a supporting shaft, the supporting shaft being connected with one end of the spindle, another end of the supporting shaft being inserted to one end of the shaft through hole of the shaft sleeve and mated with the shaft through hole, another end of the shaft through hole being threadedly connected with the adjusting nut, an outer wall of the spindle being provided with two opposing wing plates, the wing plates dividing the spindle into a left curved surface and a right curved surface, the left curved surface and the right curved surface being arranged in a symmetrical and interlaced manner so that two ends of each wing plate and the left and right curved surfaces forming a high junction and a low junction, the lower junction being formed with an oil gap, each wing plate being mated with a corresponding one of the oil valve plates and slidably mated with the wall of the inner cavity of the shaft sleeve, each oil valve plate being provided with at least one oil hole, two sides of each wing plate of the rotating shaft being provided with pressure regulation passages communicating with the inner cavity of the shaft sleeve and an outer end face of the supporting shaft, the adjusting nut being provided with a platform surface to get contact with the outer end face of the supporting shaft for sealing the pressure regulation passages
wherein each oil valve plate has two vertical sides and a transverse side to form a U-shaped configuration, one of the two vertical sides is mated with a corresponding one of the wing plates, and the other vertical side is provided with two spaced oil holes, the transverse side of each oil valve plate has a size greater than a thickness of the corresponding wing plate of the rotating shaft, the corresponding wing plate is disposed between the two vertical sides of each oil valve plate, and the two oil valve plates are disposed between the two oil separating ribs of the shaft sleeve.

2. (canceled)

3. The rotary buffer capable of adjusting damping as claimed in claim 1, wherein the rotating shaft includes a rotating ring rotatably mated with an opening of the inner cavity of the shaft sleeve, one end of the rotating ring is connected with the spindle, the end of the rotating ring, connected with the spindle, is an inner annular surface, the inner annular surface of the rotating ring is slidably mated with tops of the oil separating ribs, and the inner annular surface is provided with a pair of oil grooves to open oil passages at two sides of the oil separating ribs when the rotating shaft is not rotated.

4. The rotary buffer capable of adjusting damping as claimed in claim 3, wherein an outer circumference of the rotating ring of the rotating shaft is formed with a neck, and a sealing ring is fitted in the neck to seal the rotating ring and the opening of the shaft sleeve.

5. The rotary buffer capable of adjusting damping as claimed in claim 4, wherein the wing plates of the rotating shaft are disposed between an inner end face of the supporting shaft and the inner annular surface of the rotating ring, one end of each wing plate is connected to the inner annular surface of the rotating ring, and another end face of each wing plate is slidably mated with an inner cavity bottom surface of the rotating shaft.

6. The rotary buffer capable of adjusting damping as claimed in claim 1, wherein the pressure regulation passages are axial grooves extending from the outer end face of the supporting shaft to the spindle, and the platform surface is separated from the outer end face of the supporting shaft to form a gap to communicate with each of the axial grooves.

7. The rotary buffer capable of adjusting damping as claimed in claim 1, wherein an axial lower end face of each wing plate is in contact with and rotatably mated with a bottom surface of the inner cavity of the shaft sleeve.

8. The rotary buffer capable of adjusting damping as claimed in claim 1, wherein a bottom surface of the inner cavity of the shaft sleeve is formed with a pair of oil discharge grooves symmetrically arranged beside the two oil separating ribs for the wing plates and axial lower end faces of the oil valve plates to form gaps respectively.

9. The rotary buffer capable of adjusting damping as claimed in claim 4, wherein the opening of the shaft sleeve is provided with a press lid by welding, and a gasket is provided between the press lid and an outer annular surface of the rotating ring.

10. The rotary buffer capable of adjusting damping as claimed in claim 1, wherein the adjusting nut is provided with an annular groove, the annular groove is fitted with an O-shaped sealing ring for the adjusting nut and the shaft through hole at a bottom of the shaft sleeve to be sealed.
